(19) United States
(12) Patent Application Publication
(10) Pub. No.: US 2009/0015188 A1
(43) Pub. Date: Jan. 15, 2009

(54) METHOD FOR SUPPRESSING VARIATION IN SPEED OF ACTUATOR

(76) Inventors: Kozo Sasaki, Nagano (JP); Kunio Miyashita, Nagano (JP)

Correspondence Address: BUCHANAN, INGERSOLL & ROONEY PC, POST OFFICE BOX 1404, ALEXANDRIA, VA, 22313-1404, US

(21) Appl. No.: 12/279,145

(22) PCT Filed: Mar. 2, 2006
(86) PCT No.: PCT/JP2006/303984

§ 371 Date: Aug. 12, 2008

(51) Int. Cl. G05B 19/404

(52) U.S. Cl. 318/632

(57) ABSTRACT

The drive controller of an actuator previously measures positioning error of an actuator output shaft caused by the angle transmission error of a wave gear drive and stores it as correction data. In a feedback control loop, a speed feedback value ωf is computed using the detected position feedback value θf, after corrected by the correction data, of the actuator output shaft, and a current command Ir is computed using it, thus performing drive control on a motor. Since a speed component caused by the angle transmission error of the wave gear drive has been added to the rotational speed of a motor with regard to the speed feedback value ωf, a variation in rotational speed of the actuator output shaft caused by the angle transmission error of a wave gear drive can be suppressed effectively.

### TECHNICAL FIELD

The present invention relates to a method for suppressing variation in the speed of an actuator, in which variation in the rotational speed of an actuator output shaft caused by angle transmission error of a wave gear drive is suppressed in an actuator provided with the wave gear drive. The present invention also relates to a drive controller of an actuator in which this method for suppressing variation in speed is employed.

### BACKGROUND ART

Well-known actuators include configurations in which the rate of output rotation of a motor is reduced by a wave gear drive, and a load-side member is held in a target position. The wave gear drive is provided with an annular, rigid internally-toothed gear, an annular, flexible externally-toothed gear, and a wave generator. In a typical wave gear drive, a state is created in which the flexible externally-toothed gear is bent into an elliptical shape by the wave generator, and the external tooth portions positioned on both ends of this elliptical shape in the major axial direction are engaged with corresponding internal tooth portions of the rigid internally-toothed gear. Once the motor causes the wave generator to rotate, the engagement positions of the two gears move in the circumferential direction, and relative rotation between the two gears is generated according to the difference 2n (where n is a positive integer) in the number of teeth between the two gears.

In general, the difference in the number of teeth between the two gears is two. The rigid internally-toothed gear is fixed, and the flexible externally-toothed gear rotates as an element for outputting reduced-speed rotation. The load-side member that is linked to the flexible externally-toothed gear is rotationally driven at a low speed. The reduction ratio i in this instance is represented by the equation below.

i=1/R=(Zc−Zf)/Zf
R: Gear ratio
Zf Number of teeth of the flexible externally-toothed gear
Zc: Number of teeth of the rigid internally-toothed gear

When, e.g., Zf=100 and Zc=102, the reduction ratio i is 1/50, and the output rotation moves in the opposite direction from direction of rotation of the motor.

The drive controller of an actuator having this configuration generally controls the positioning of the actuator using feedback control. Angle transmission error occurs in the wave gear drive in this instance. Error occurs between the target position and the actual position of the actuator output shaft (the output shaft of the wave gear drive) due to this angle transmission error. The positioning accuracy of the actuator provided with the wave gear drive could be improved if this error could be compensated for.

Methods for correcting the positioning error of an actuator are proposed in Patent Documents 1, 2, in which positioning error caused by angle transmission error of the wave gear drive is corrected, and positioning is accurately performed. Position accuracy is improved in Patent Document 1 by adding a degree of correction to the positioning feedback, and in Patent Document 2 by adding a degree of correction to the positioning command.

However, variations in the rotational speed of the actuator output shaft occur due to the effects of an error component in the wave gear drive in actuators provided with a wave gear drive. Such variations in rotational speed cannot be suppressed in conventional methods for correcting positioning error.
[Patent Document 1] JP-A 2002-175120
[Patent Document 2] JP-A 2003-223225

### DISCLOSURE OF THE INVENTION

With the foregoing problems in view, it is an object of the present invention to propose a method for suppressing variation in the speed of an actuator that is capable of effectively suppressing variations in the rotation of an actuator output shaft caused by angle transmission error of a wave gear drive. It is also an object to propose a drive controller for an actuator in which this method is employed.

In order to achieve the aforementioned objects, in the present invention, a positioning error of an actuator output shaft caused by angle transmission error of a wave gear drive in an actuator provided with the wave gear drive is measured in advance; the speed of the actuator output shaft is computed in a speed-controlling feedback loop thereof using the result of correcting detected positioning information of the actuator output shaft using the positioning error; and this information is used as a speed feedback value. Alternatively, the result of using the detected positioning error to correct the speed computed from the detected positioning information is used as the speed feedback value.

In other words, in the method for suppressing variation in speed of an actuator of the present invention, an absolute position of one revolution of the motor rotating shaft is used as a reference to measure a positioning error of each rotational angle position of an actuator output shaft and create error correction data for the actuator output shaft for each of the rotational angle positions of the motor rotating shaft. During drive control, a rotational position of the motor rotating shaft is detected, the error correction data is used to determine an error-correction value allocated to the detected rotational position, and the speed of the motor rotating shaft is computed from a value obtained from using the error-correction value to correct the rotational position. Alternatively, the speed of the motor rotating shaft calculated from the rotational position is corrected on the basis of the error-correction value, and the determined speed is used as a speed feedback value for feedback control of the actuator output shaft.

In the present invention, the absolute position of one revolution of the motor rotating shaft is used as a reference to measure the positioning error of the actuator output shaft for at least one revolution of the actuator output shaft, and create error correction data.

The positioning error in the measured rotational positions are averaged in this instance, and error correction data representing the error-correction values for each of the rotational positions of one revolution of the motor rotating shaft can be created.

The error correction data can be made as a correction-pulse data string acting as error correction information for each of the rotational positions of one revolution of the motor rotating shaft, or can be made as a coefficient string for an approximation formula representing errors in each of the rotational positions of one revolution of the motor rotating shaft.

The present invention is also related to a drive controller of an actuator for suppressing variation in speed using the aforedescribed method, the drive controller being characterized by comprising a part for storing error correction data in which the error correction data is stored; a position detector attached to the motor rotating shaft; and a feedback-control part for performing feedback control so as to cause the actuator output shaft to arrive at a target position designated by position command information using, as a speed feedback value, a detection position of the motor rotating shaft detected by the position detector and a speed of the motor rotating shaft computed on the basis of the error correction data.

The feedback-control part may also perform feedback control so that the actuator output shaft arrives at a target speed designated by speed command information.

In the speed feedback values used for feedback control of the actuator in the present invention, a speed component caused by the angle transmission error of the wave gear drive is added to the speed computed from the detected position of the motor rotating shaft. Feedback is therefore used to control the speed, whereby variation in the rotational speed of the actuator output shaft caused by angle transmission error of the wave gear drive can be effectively suppressed.

### BRIEF DESCRIPTION OF THE DRAWINGS

FIG. 1 is a schematic block diagram that shows an example of a drive controller of an actuator in which the present invention is applied;

FIG. 2 is a chart for describing the method for creating correction data in the drive controller of FIG. 1;

FIG. 3 is a chart that shows a correspondence table for the correction data that is created; and

FIG. 4 is a schematic block diagram that shows another example of a drive controller of an actuator in which the present invention in applied

### KEY

1, 1A Drive controller
2 Actuator
3 Motor
4 Motor rotating shaft
5 Wave gear drive
6 Position detector
7 Actuator output shaft
8 Rotational position information
11 Feedback-control part
12 Correction-data storing part
13 Position-controlling part
14 Speed-controlling part
15 Speed-computing part
16 Current-amplifying part
C Error correction data
θf Position feedback value
ωf Speed feedback value
θr Position command
ωr Speed command
Ir Current command

### BEST MODE FOR CARRYING OUT THE INVENTION

An example of a drive controller of an actuator in which the method of the present invention is applied will be described below with reference to the drawings.

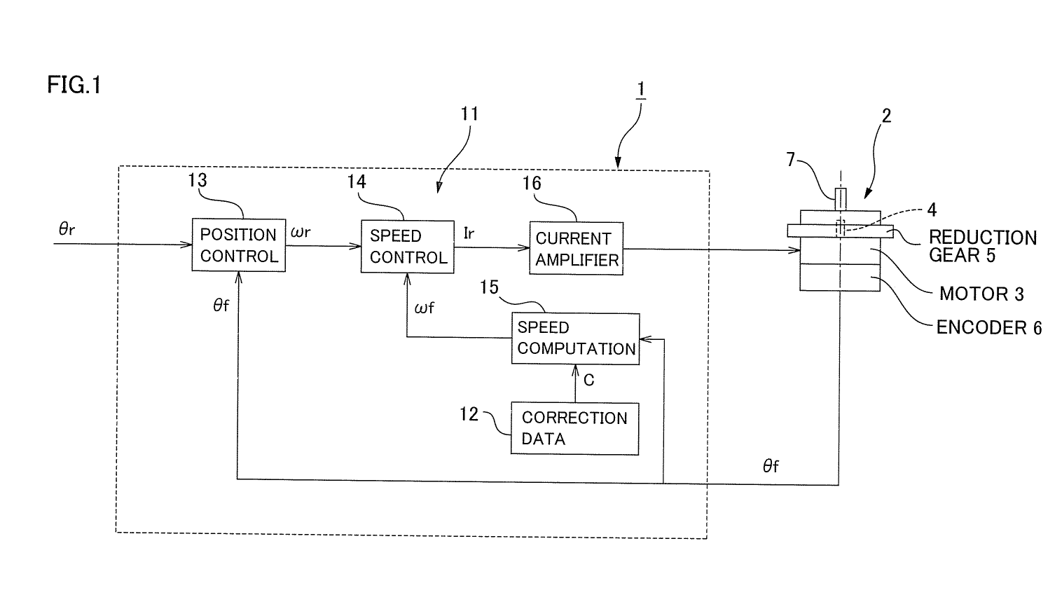

FIG. 1 is a schematic structural diagram that shows a drive controller of an actuator of the present example. An actuator 2 of the present example that is driven by this drive controller 1 comprises a motor 3, a wave gear drive 5 linked to a motor rotating shaft 4, and a position detector 6 that is capable of detecting the rotational position of the motor rotating shaft 4. The output shaft, i.e., an actuator output shaft 7, of the wave gear drive 5 is linked to a load (not shown). The position detector 6 is a rotary encoder, potentiometer, or another position detector that is capable of detecting absolute position.

The drive controller 1 for controlling the driving of the actuator 2 comprises a feedback-control part 11 for performing feedback control so that the actuator 2 assumes a target position designated by a position command θr from a high-level device; and a correction-data storing part 12 in which is stored error correction data C representing position errors caused by angle transmission error of the wave gear drive 5. In the feedback-control part 11, a speed command θr is computed on the basis of the difference between the position command θr and a position feedback value θf from the position detector 6 in the position-controlling part 13 and is supplied to the speed-controlling part 14. In the speed-controlling part 14, a current command Ir is computed on the basis of the difference between the speed command ωr and a speed feedback value ωf supplied from a speed-computing part 15 and is supplied to a current-amplifying part 16. A motor-driving current is supplied to the motor 3 via the current-amplifying part 16.

In the speed-computing part 15, the position feedback value θf supplied from the position detector 6 is corrected on the basis of the correction data C, and the speed feedback value ωf is computed from the corrected value. The corrected value is determined by, e.g., adding or subtracting the correction data C relative to the position feedback value θf, and the speed feedback value ωf is computed from the corrected value. The equation for calculating the speed in this instance is as follows, where Δt is the sampling period.

ωf=((θf(t)+C(t))−(θf(t−1)+C(t−1)))/Δt

(Correction Data)

The correction data C of the present example is created as follows. First, the positioning error of the motor rotating shaft 4 in the actuator 2 is compressed by a factor of the reduction ratio of the wave gear drive 5 due to the reduction of the wave gear drive 5 connected to the motor rotating shaft. When the gear ratio of the wave gear drive 5 is, e.g., 50 or 100, the positioning error of the motor itself is compressed to 1/50 or 1/100, respectively. The positioning error of the actuator 2 is therefore primarily caused by angle transmission error of the wave gear drive 5, and therefore the positioning error of the actuator 2 in a single direction is determined by the angle transmission error of the wave gear drive 5.

Positioning is performed continuously in a single rotational direction, and the difference between the actual rotation angle and the intended rotation angle is determined for each position using reference positions. The single-direction positioning accuracy is the maximum of these values during course of one revolution.

The single-direction positioning accuracy of the actuator 2 in the present example, i.e., the positioning error of the actuator 2, is measured for one revolution of the actuator output shaft 7 on the basis of the absolute position of the motor rotating shaft 4. When the gear ratio of the wave gear drive 5 is, e.g., 1/50, the output shaft 7 rotates once for every 50 rotations of the motor rotating shaft 4.

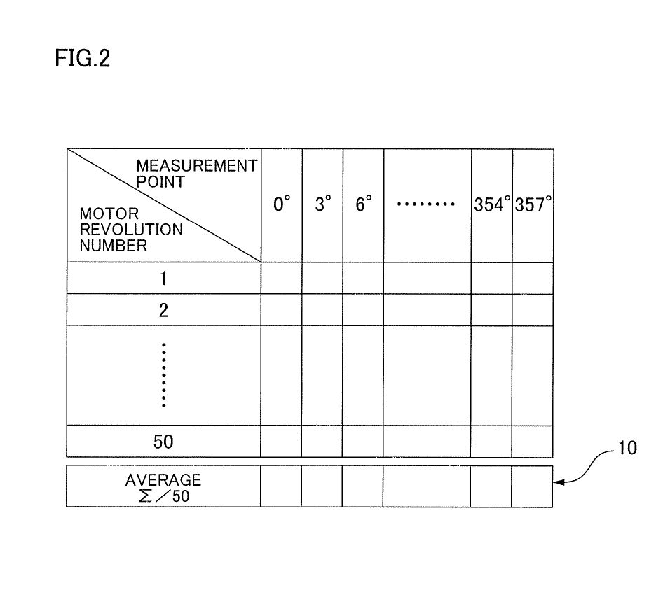

The positioning error is measured for every, e.g., 3° of rotation of the motor rotating shaft 4 on the basis of the output of the position detector 6, as shown in FIG. 2. Measurement of the motor rotating shaft 4 is performed at 120 points (360°/3°) in this instance, and for the actuator output shaft 7, these 120 points are multiplied by the gear ratio.

The measured data is substantially the same even when the angle transmission accuracy of the wave gear drive is used instead of the single-direction positioning accuracy.

It shall also be apparent that measurement may be performed not just for one revolution but for one or more revolutions of the actuator output shaft 7.

The error data for each measurement point, e.g., the error data for 120 locations, are averaged, and the correction data C for one revolution of the motor rotating shaft 4 is created as shown in the lowest row in the table in FIG. 2.

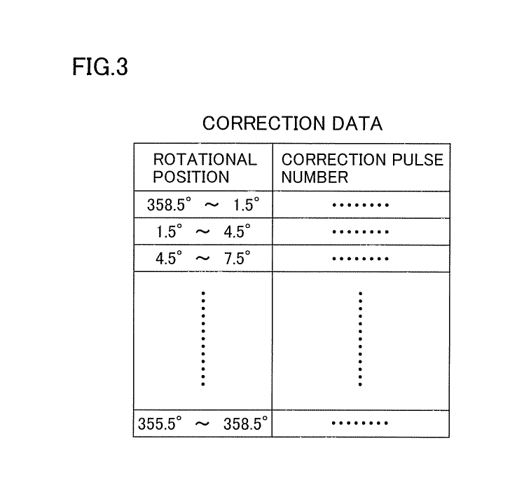

The format of the created correction data C may be a correction pulse number for error correction for each of the rotational angle positions in one revolution of the motor rotating shaft 4. Correction pulse numbers measured for each, e.g., 3°, as above, can be put into a correspondence table for the allocations of rotational positions for every 3° of rotation of the motor rotating shaft 4, as shown in FIG. 3.

Alternatively, the correction data for one revolution of the motor rotating shaft 4 may be expanded into a Fourier series and an approximation curve determined. The coefficients of the Fourier series represented by the approximation curve may be stored and saved as the correction data C. In this case, an initialization process may be performed when the driving current of the drive controller 1 is turned on, in which the stored coefficients are put into the approximation formula to calculate the correction data, and correction-pulse data strings are created as shown in FIG. 3.

In the drive controller 1 of an actuator of the present example as described above, positioning error caused by angle transmission error of the wave gear drive 5 is measured in advance, and correction data C representing the positioning error in the rotational positions of the motor rotating shaft 4 is created. In the feedback control loop for controlling the motor, error correction values for the rotational positions are determined from the correction data C on the basis of the absolute position of the motor rotating shaft 4. The speed feedback value ωf is calculated while taking these error correction values into account, and the current command Ir for drive control of the motor is computed using this speed feedback value ωf. In the computed speed feedback value, the speed component caused by angle transmission error of the wave gear drive 5 is added to the rotational speed of the motor rotating shaft 4, and the speed is feedback controlled. Variations in the rotational speed of the actuator output shaft 7 caused by angle transmission error of the wave gear drive 5 can thereby be effectively suppressed.

Feedback control is performed on the basis of the position command θr from a high-level device in the present example, but feedback control may also be performed on the basis of the speed command ωr from a high-level device.

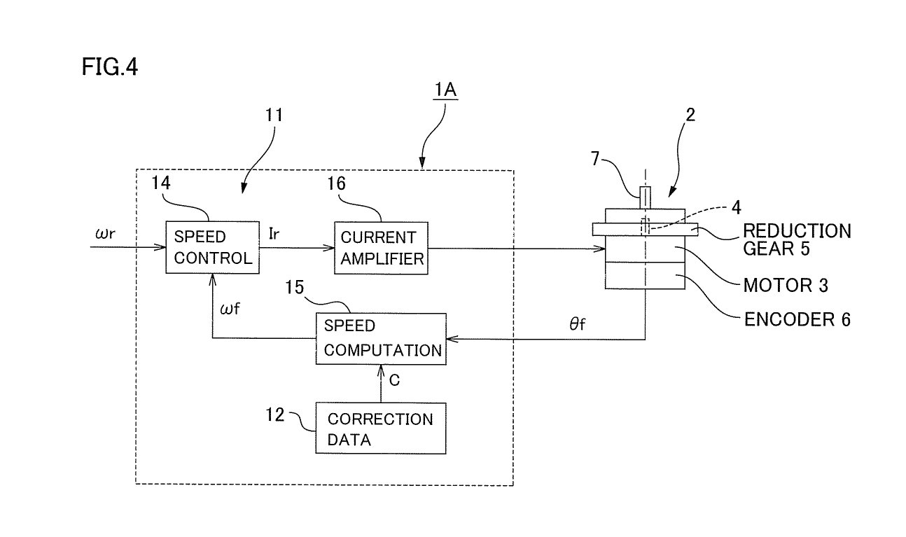

FIG. 4 is a schematic structural diagram that shows an example of a drive controller of an actuator in such instances. As shown in FIG. 4, the position-controlling part 13 is omitted from this drive controller 1A, but the rest of the configuration is identical to the drive controller 1. The same notation is therefore applied to the corresponding parts of FIG. 4. An operational effect identical to that of the aforedescribed drive controller 1 can also be obtained in this configuration.

1. A method for suppressing variation in rotational speed of an output shaft of an actuator provided with a motor and a wave gear drive, the method for suppressing variation in speed of an actuator in comprising:
using an absolute position of one revolution of a motor rotating shaft as a reference to measure a positioning error of each rotational angle position of the actuator output shaft and create error correction data for the actuator output shaft for each of the rotational angle positions of the motor rotating shaft;
detecting a rotational position of the motor rotating shaft;
using the error correction data to determine an error-correction value allocated to the detected rotational position;
computing the speed of the motor rotating shaft from a value obtained from using the error-correction value to correct the rotational position, or, alternatively, correcting the speed of the motor rotating shaft calculated from the rotational position on the basis of the error-correction value; and
using the determined speed as a speed feedback value for feedback control of the actuator output shaft.

2. The method for suppressing variation in speed of an actuator according to claim 1, wherein using the absolute position of one revolution of the motor rotating shaft as a reference to measure the positioning error of the actuator output shaft for at least one revolution of the actuator output shaft, and create error correction data.

3. The method for suppressing variation in speed of an actuator according to claim 2, wherein averaging the positioning errors of the measured rotational positions, and creating error correction data representing the error-correction values for each of the rotational positions of one revolution of the motor rotating shaft.

4. The method for suppressing variation in speed of an actuator according to claim 3, the method for suppressing variation in speed of an actuator wherein the error correction data is a correction-pulse data string acting as error correction information for each of the rotational positions of one revolution of the motor rotating shaft, or is a coefficient string for an approximation formula representing errors in each of the rotational positions of one revolution of the motor rotating shaft.

5. A drive controller of an actuator for suppressing variation in speed using the method according to claim 1, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target position designated by position command information using, as a speed feedback value, a detection position of the motor rotating shaft detected by the position detector and a speed of the motor rotating shaft computed on the basis of the error correction data.

6. A drive controller of an actuator for suppressing variation in speed using the method according to claim 1, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target speed designated by speed command information using, as a speed feedback value, a detection position of the motor rotating shaft detected by the position detector and a speed of the motor rotating shaft computed on the basis of the error correction data.

7. A drive controller of an actuator for suppressing variation in speed using the method according to claim 2, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target position designated by position command information using, as a speed feedback value, a detection position of the motor rotating shaft detected by the position detector and a speed of the motor rotating shaft computed on the basis of the error correction data.

8. A drive controller of an actuator for suppressing variation in speed using the method according to claim 3, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target position designated by position command information using, as a speed feedback value, a detection position of the motor rotating shaft detected by the position detector and a speed of the motor rotating shaft computed on the basis of the error correction data.

9. A drive controller of an actuator for suppressing variation in speed using the method according to claim 4, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target position designated by position command information using, as a speed feedback value, a detection position of the motor rotating shaft detected by the position detector and a speed of the motor rotating shaft computed on the basis of the error correction data.

10. A drive controller of an actuator for suppressing variation in speed using the method according to claim 2, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target speed designated by speed command information using, as a speed feedback value, a detection position of the motor rotating shaft detected by the position detector and a speed of the motor rotating shaft computed on the basis of the error correction data.

11. A drive controller of an actuator for suppressing variation in speed using the method according to claim 3, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target speed designated by speed command information using, as a speed feedback value, a detection position of the motor rotating shaft detected by the position detector and a speed of the motor rotating shaft computed on the basis of the error correction data.

12. A drive controller of an actuator for suppressing variation in speed using the method according to claim 4, the drive controller of an actuator comprising:
a part for storing error correction data in which the error correction data is stored;
a position detector attached to the motor rotating shaft; and
a feedback-control part for performing feedback control so as to cause the actuator output shaft to arrive at a target speed designated by speed command information using, as a speed feedback value, a detection position of the motor rotating shaft detected by the position detector and a speed of the motor rotating shaft computed on the basis of the error correction data.
